(19) United States
(12) Patent Application Publication
(10) Pub. No.: US 2008/0271500 A1
(43) Pub. Date: Nov. 6, 2008

(54) Laundry Machine

(75) Inventor: In Geun Ahn, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/628,320

(22) PCT Filed: Mar. 23, 2006
(86) PCT No.: PCT/KR06/01074

§ 371 Date: Jan. 25, 2008

(30) Foreign Application Priority Data
Mar. 25, 2005 (KR) 10-2005-0025041
Mar. 25, 2005 (KR) 10-2005-0025127

(51) Int. Cl. D06F 39/08; B08B 3/00

(52) U.S. Cl. 68/5 C

(57) ABSTRACT

A laundry machine is disclosed. A laundry machine includes a body (100) for defining an exterior, a water supply valve (200) provided in the body (100) and connected with an outer water supply device, a drum rotatably mounted within the body, at least one steam generator for supplying steam into the drum (600), and a water treatment apparatus (900) for treating water supplied to the steam generator (600). an object of the present invention is to provide a laundry machine which can perform washing and drying more quickly and efficiently as well as which has an effect of smoothing out wrinkles and sterilizing the laundry.

### TECHNICAL FIELD

The present invention relates to a laundry machine, and more particularly, to a steam generator for washing/drying laundry fast and efficiently as well as for having a refreshing effect of sterilizing the laundry and smoothing out wrinkles of the laundry, and a laundry machine having the same.

### BACKGROUND ART

In general, a drum type laundry machine washes laundry by using both friction force between a drum rotated by a motor and the laundry, in a state where the laundry and detergent are mixedly loaded into a drum. Thus, the drum type laundry machine has an effect that the laundry may not be damaged, nor get entangled, and that the laundry may be washed as if it were scrubbed by human hands.

Also, a drum type laundry machine with a drying function is an appliance capable of not only washing laundry like a conventional drum type laundry machine but also drying washed laundry.

Here, the drum type laundry machine with a drying function dries the laundry by hot air supplied into a drum through a drying duct having a drying heater and a ventilating fan therein.

However, the conventional drum type laundry machine has following problems.

First, the conventional drum type laundry machine has a problem of much consumption of wash water, because a soaking cycle using a lot of wash water should be performed before washing.

That is, since the laundry should be dampened in wash water in a soaking cycle, a lot of wash water is needed.

Second, the conventional drum type laundry machine has another problem that any auxiliary structure is not provided therein for sterilizing the laundry.

Though not shown in drawings, recently there has been released a laundry machine which has another heater for wash water therein for sterilizing the laundry, but that laundry machine is not preferred due to too much consumption of wash water as well as energy used in a sterilizing cycle, because the laundry is simply sterilized in wash water.

Finally, the conventional drum type laundry machine has still another problem of inconvenience that additional ironing is necessary due to wrinkles generated in washing.

Especially, when a drying cycle is performed within the drum in spite of a lot of wrinkles, it is more difficult as well as inconvenient for a user to iron the laundry with the wrinkles.

### DISCLOSURE OF INVENTION

### Technical Problem

An object of the present invention is to provide a laundry machine which can perform washing and drying more quickly and efficiently as well as which has an effect of smoothing cut wrinkles and sterilizing the laundry.

### Technical Solution

To achieve these objects and other advantages and in accordance with the purpose of the invention, as embodied and broadly described herein, a laundry machine. A laundry machine includes a body for defining an exterior; a water supply valve provided in the body and connected with an outer water supply device; a drum rotatably mounted within the body; at least one steam generator for supplying steam into the drum; and a water treatment apparatus for treating water supplied to the steam generator.

Here, if the water treatment apparatus is provided within the tub, it may be a drum type laundry machine. if the water treatment apparatus is not provided within the tub, it may be a dryer.

The water treatment apparatus is provided in a pipe connecting the outer water supply device and the water supply valve, and the water treatment apparatus is provided in a pipe connecting the water supply valve and the steam generator.

More specifically, the water treatment apparatus is a water softening device which makes water soft. The water treatment apparatus includes a case having an inlet for drawing water therein and an outlet for discharging softened water, the case having space for allowing an interior material therein where the drawn water is softened.

Also, the interior material includes ion-exchange resin and salt solution for recycle.

The water treatment apparatus may be a filtering device for filtering water. The filtering device comprises a mesh type porous filter.

Meanwhile, preferably, the water treatment apparatus prevents scale from being generated in the steam generator.

Here, the steam generator includes a steam generating part having a predetermined water inflow space therein for allowing water to flow therein, the steam generating part having a water inlet and an outlet respectively connected with the water inflow space, a water inlet path connecting between the water supply valve and the water inlet of the steam generating part, an outlet path connecting between the outlet of the steam generating part and the tub, and a heater for heating water flown to the water inflow space to generate steam.

Also, the steam generating part is provided within the body of the laundry machine so that the outlet may be positioned higher than the water inlet based on a horizon. The cross section of the steam generating part is larger than the cross section of the water inlet path and of outlet path. The cross section of the outlet path is smaller than the cross section of the water inlet path.

Meanwhile, the water inlet path includes a water supply pipe having a first end thereof connected with the water supply valve, and a water inlet pipe having a first end connected with the second end of the water supply pipe and a second end thereof connected with the water inlet of the steam generating part. Preferably, the water treatment apparatus is provided in the water supply pipe.

The seam generator further comprises a bypass path for discharging water over flown from the water inflow space of the steam generating part.

The outlet path includes an outlet pipe having a first end thereof connected with the outlet of the steam generating part, and a steam supply pipe having a first end connected a second end of the outlet pipe and a second end thereof connected with the tub. The end of the steam supply pipe discharging steam is formed in a nozzle shape.

In another aspect of the present invention, a laundry machine includes a body for defining an exterior, a water supply valve provided in the body and connected with an outer water supply device, a tub provided within the body, a drum rotatably mounted within the tub, a hot air supply device for generating and supplying hot air into the drum through the drying duct, at least one steam generator for supplying steam into the drum, and a water treatment apparatus for treating the water supplied to the steam generator from the water supply valve.

Here, the steam generated in the steam generator is supplied into the drum through the drying duct. Preferably, the steam is supplied into the drum together with the hot air generated in the hot air supplying device.

### Advantageous Effects

The present invention has an advantageous effect of enhanced washing efficiency as well as economizing in wash water in a washing cycle.

Furthermore, the present invention has another advantageous effect of enhanced drying efficiency as well as removing wrinkles of laundry and sterilizing the laundry in a drying cycle.

Still further, the present invention has another advantageous effect of enhancing user satisfaction due to the refreshing function of laundry.

Still further, the present invention has another advantageous effect of generating and supplying steam more efficiently due to smooth wash water supply of the steam generator in case of the counter-pressure of water in the steam generator.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 is a side sectional view schematically illustrating a drum type laundry machine with a drying function according to an embodiment of the present invention.

FIG. 2 is a front sectional view schematically illustrating the structure of drum type laundry machine with a drying function according to the first embodiment of the present invention.

FIG. 3 is a sectional view schematically illustrating a drum type laundry machine with a drying function according the first embodiment of the present invention.

FIG. 4 is a perspective view schematically illustrating a steam generator of FIG. 3.

FIG. 5 is a sectional view in accordance with a I-I line of FIG. 4.

FIG. 6 is a sectional view in accordance with a II-II line of FIG. 4.

FIG. 7 is a side sectional view schematically illustrating a structure of a water treatment apparatus provided between an outer water supply device and a water supply valve.

FIG. 8 is a front sectional view schematically illustrating another structure of the steam generator of the laundry machine according to the present invention.

FIG. 9 is a perspective view schematically illustrating a steam generator of a laundry machine according to another embodiment of the present invention.

FIG. 10 is a sectional view of a III-III line of FIG. 9.

FIG. 11 is a side sectional view schematically illustrating a case that another type of steam generator is applied the laundry machine.

FIG. 12 is a perspective view schematically illustrating the steam generator of FIG. 11.

### BEST MODE FOR CARRYING OUT THE INVENTION

Reference will now be made in detail to the preferred embodiments of the present invention, examples of which are illustrated in the accompanying drawings. This embodiment presents a drum type laundry machine as an example of a laundry machine according to the present invention.

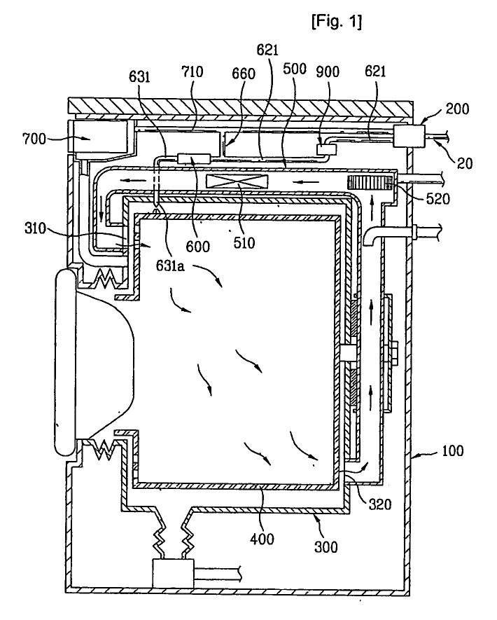

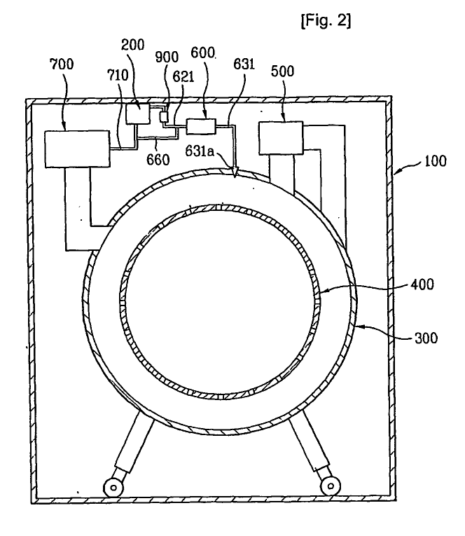

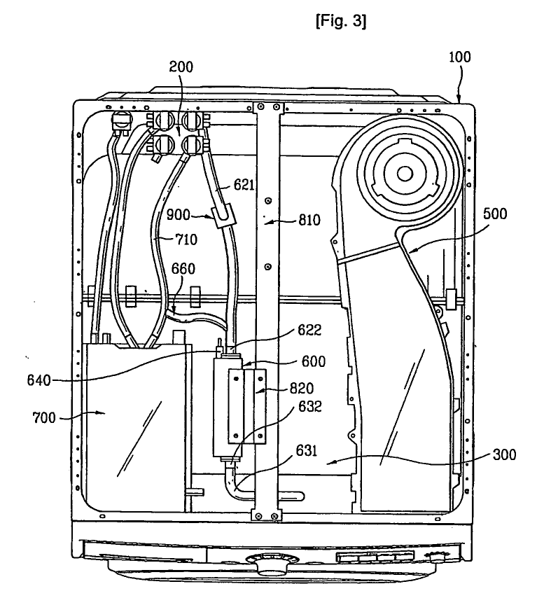

FIG. 1 is a side sectional view schematically illustrating a drum type laundry machine with a drying function according to an embodiment of the present invention. FIG. 2 is a front sectional view schematically illustrating the structure of drum type laundry machine with a drying function according to the first embodiment of the present invention. FIG. 3 is a sectional view schematically illustrating a drum type laundry machine with a drying function according the first embodiment of the present invention.

Although a drum type laundry machine is embodied on convenience sake, the present invention is not limited to a drum type laundry machine, and also may be applied to a laundry machine which can perform washing, dehydrating and drying respectively or simultaneously. For example, even in case of a dryer only performing drying, a steam generator according to the present invention may be applied thereto.

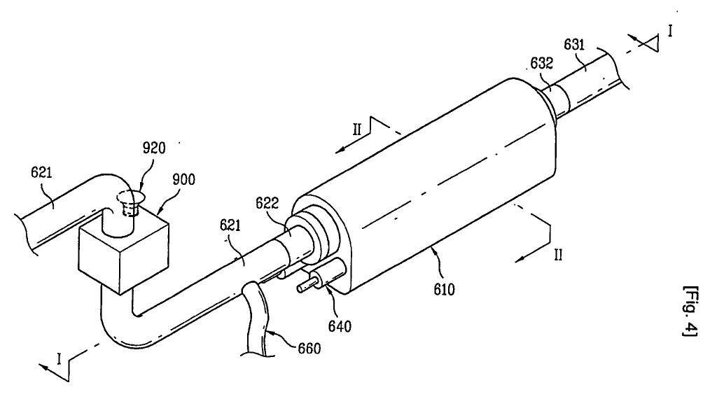

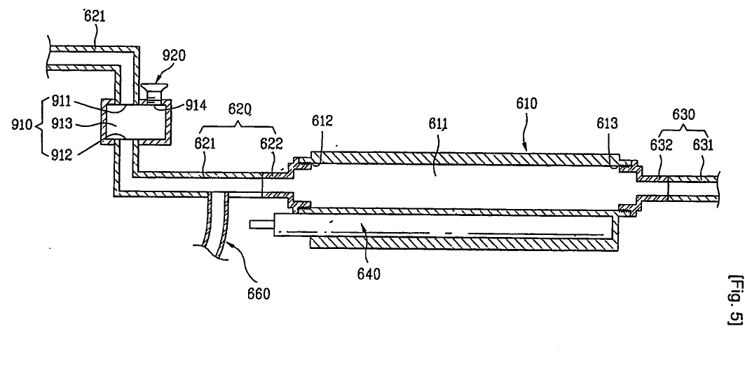

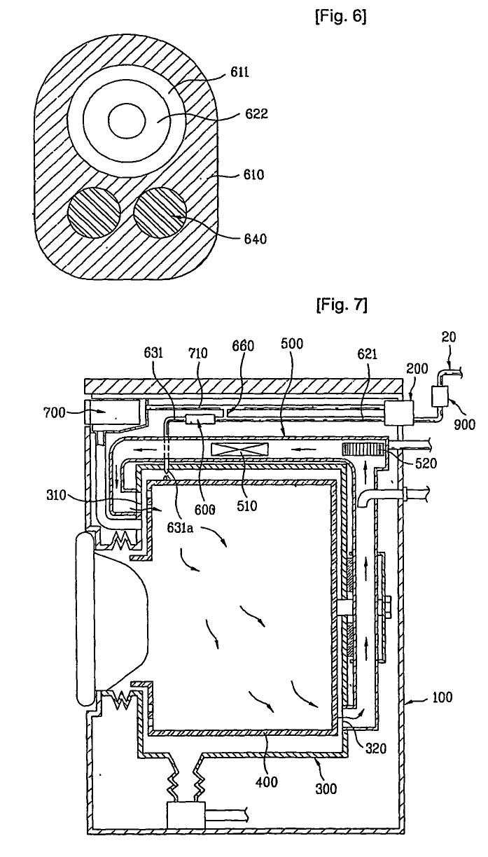

Moreover, FIG. 4 is a perspective view schematically illustrating a steam generator of FIG. 3. FIG. 5 is a sectional view in accordance with a I-I line of FIG. 4. FIG. 6 is a sectional view in accordance with a II-II line of FIG. 4.

As shown in FIGS. 1 and 2, a drum type laundry machine with a drying function includes a body 100 for defining an exterior, a water supply valve 200 provided within the body 100 and connected with an outside water supply facility 20, a tub 300 of an approximately cylindrical shape mounted within the body 100 for having a hot air inlet 310 and a hot air outlet 320 formed therein, a drum 400 rotatably mounted within the tub 300, a drying duct 500 having a drying heater 510 for heating air supplied into the drum 400 and a ventilation fan 520 for forcibly ventilating the hot air heated by the drying heater 510 into the drum 400 to form an air inflow for supplying hot air, at least one of steam generators 600 for supplying steam into the drum 400, and a water treatment apparatus for treating the water supplied into the steam generator 600.

Here, the drying heater 510, the ventilation fan 520 and drying duct 500 are employed for supplying hot air into the drum, and thereby they may be included in a hot air supply device.

As shown in FIGS. 3 to 6, the steam generator 600 with predetermined water inflow space 611 flowing water therein includes a steam generating part 610 having a water inlet 612 and an outlet 613 respectively connected with the water inflow space 611, a water inlet path 620 connected between the water supply valve 200 and the water inlet 612 of steam generating part 610, an outlet path 630 connected between the outlet 613 of the steam generating part 610 and the tub 300, a bypass path 660 for discharging overflowing water from the water inflow space 611 of steam generating part 610, and a heater 640 for heating the water flown to the water inflow space 611 of steam generating part 610.

Also, the steam generator 600 further includes a temperature sensor (not shown) for sensing the temperature of steam generating part 610.

The temperature sensor is provided so as to control the heater 640 based on the temperature of steam generating part 610. Preferably, the heater 640 is prevented from being overheated, because a temperature fuse is cut off at the temperature higher than the predetermined temperature and power supplying to the heater is shut off.

As shown in FIGS. 4 to 6, since the steam generating part 610 is formed in a tube shape, the water inflow space 611 is also formed in a tube shape. The water inlet 612 and the outlet 613 of steam generating part 610 are respectively formed at opposite ends of steam generating part 610.

Also, the steam generating part 610 is inclined such that the outlet 613 is positioned higher than the water inlet 612 based on a horizon. Thereby, water is prevented from being discharged through the outlet 613.

The cross section of water inflow space 611 in the steam generating part 610 is larger the cross section of water inlet path 620 and the cross section of outlet path 630 to smoothly supply water into the water inflow space 611 as well as to smoothly discharge steam from the water inflow space 611.

Also, preferably the cross section of outlet path 630 is smaller than the cross section of water inlet path 620.

That is for steam to be discharged into the outlet path 630 more smoothly by causing pressure difference between the inside of outlet path 630 and the inside of water inlet path 620, which is generated by water flowing into the water inflow space 611 from the water inlet path 620.

Preferably, the steam generating part 610 is made of metal with good conductivity and with small specific gravity such as aluminum in a die-casting method.

The water inlet path 620 includes a water supply valve 200 (see FIG. 3), a water supply pipe 621 connected with the water supply valve and a water inlet pipe interposed between the water supply pipe 622 and the water inlet pipe of the steam generating part 610.

Also, the outlet path 630 includes an outlet pipe 632 provided in the outlet of the steam generating part 610, and a steam supply pipe 631 connected between the outlet pipe 632 and the tub 300.

As shown in FIG. 1, it is preferred that the end of steam supply pipe 631a discharging steam is formed in a nozzle shape.

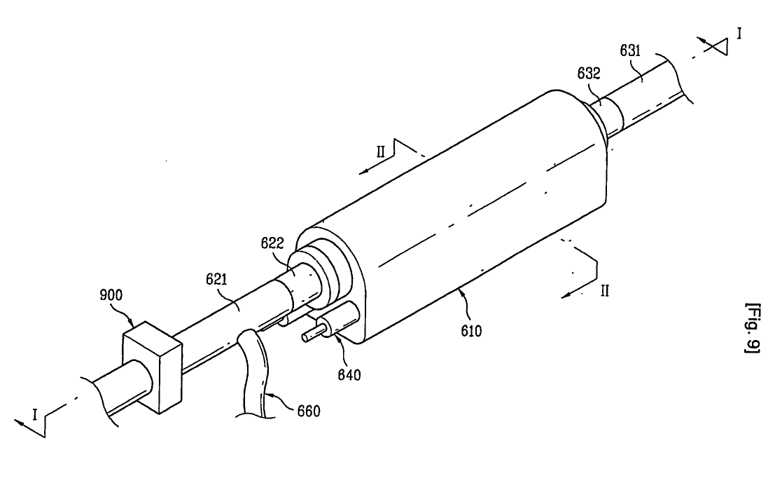

Alternatively, as shown in FIG. 8, the steam generated in the steam generator 600 may be supplied into the drying duct 500, and then may be supplied into the drum 400 through the drying duct 500.

That is, the steam supply pipe 631 is connected between the outlet 613 of the steam generating part 610 and the drying duct 500 for supplying steam into the drum 400 through the drying duct 500.

Preferably, the end of steam supply pipe 631 discharging steam is provided at the end of drying duct 500 discharging hot air.

Also, preferably, the ventilation fan 520 is operated in case that the steam discharged from the steam supply pipe 631 is supplied into the drying duct 500.

That is for preventing the steam discharged from the steam supply pipe 631 from flowing against the inflow direction of hot air.

Alternatively, in case that the steam discharged from the steam supply pipe 631 is supplied into the drying duct 500, it is preferred to drive a ventilation fan 520 within the drying duct 500 for preventing the steam discharged by the steam supply pipe 631 from flowing against the inflow direction of hot air in the drying duct 500.

Of course, in case that the steam discharged by the steam supply pipe 631 is supplied into the drying duct 500, the steam of the dying duct 500 may be supplied with the hot air into the drum by driving the drying heater 510, together with driving the ventilation fan 520 within the drying duct 500.

Referring to FIGS. 3 to 5, the bypass path 660 is connected between the water inlet path 620 of the steam generating part 610 and the path drawing water from the water supply valve 200 into the tub 300.

In other words, as shown in FIG. 3, a drawer for detergent and fabric softener is provided between the water supply valve 200 and the tub 300 for mixedly supplying wash water and detergent/fabric softener. Thus, preferably the bypass path 660 is provided on the pipe 710 connecting the water supply valve 200 with the drawer for detergent 700.

That is, the bypass path 660 is connected between the pipe 710 and the water supply pipe 621 of water inlet path 620.

Although not shown, the bypass path 660 may be directly connected with the drawer for detergent/fabric softener 700, such that water over flown from the water inflow space of steam generating part 610 into the drawer for detergent/fabric softener 700.

Again, referring to FIGS. 4 to 6, preferably the heater 640 of steam generator 600 is a sheath heater, and is embedded within the steam generating part 610 by molding and provided in surroundings of the water inflow space 611 for heating the water flowing in the water inflow space 611.

That is, since the heater 640 is embedded within the steam generating part 610 for heat-radiating, the steam generating part 610 made of aluminum is heated, such that the water flowing within the water inflow space 611 of the steam generating part 610 is heated to generate steam.

As shown in FIG. 3, the steam generator 600 with the above configuration is provided by using a bracket 810 and 820, not using the body 100 defining an exterior of the drum type laundry machine with a drying function.

An auxiliary frame 810 is provided along a front/rear direction of the body 100, and a first side of a support bracket 820 is fastened to the front side of auxiliary frame 810 and a second side of a support bracket 820 is fastened to the steam generating part 610, such that the steam generator 600 is installed in the body 100 of the drum type laundry machine with a drying function.

Preferably, the steam generating part 610 and the second side of support bracket 820 are fastened by a screw.

Although not described specifically, a fastening boss having a fastening hole is projected on the upper surface of steam generating part 610, and a fastening hole corresponding with the fastening boss is formed in the second side of support bracket 820, such that the steam generating part 610 and the support bracket 820 are connected by fastening the screw to the fastening boss and the fastening hole.

Additionally, the auxiliary fame 810 fastened to the body 100 is employed for dampening vibration and noise generated in the body in a spinning cycle, as well as for reinforcing the strength of body 100.

As shown in FIG. 3, a water treatment apparatus 900 treating the water supplied into the steam generator 600 may be provided in a water inlet pipe 620.

Here, in the water treatment apparatus, the treatment may mean all that changes physical and chemical properties of water. In other words, the water treatment apparatus may mean an apparatus which treats water to enhance washing efficiency or improve the performance of steam generator.

However, since the water treatment apparatus of the present invention is a kind of means to treat the water supplied into the steam generator 600, preferably the water treatment is performed to prevent scale from being generated in the steam generator.

Thus, the water treatment apparatus 900 may be a water softening device or a filtering device, if more specifically described. Thereby, the water softening device and the filtering device are referred to as reference number 900 in each embodiment of the present invention.

As shown in FIG. 3, the water softening device 900 is provided in the water supply pipe 621 included in the water inlet path 620 of the steam generator 600, and changes the water flowing in the water supply pipe 621 into soft water to supply the soft water into the water inflow space 611 of the steam generator 600.

Meanwhile, as shown in FIGS. 4 and 5, the water softening device 900 includes a case 910 having space 913 for allowing the drawn water softened therein due to an interior material which softens water. The interior material may be provided in various types, for example, an interior material including ion-change resin and salt solution for recycle.

Here, an inlet 911 is formed at an upper portion of the case 910 having the water supply pipe 621 connected thereto for drawing water, and an outlet 912 is formed at a lower portion of the case 910 for discharging the softened water.

Moreover, an opening 914 is formed in a side of the case upper portion for introducing ion-change resin and salt solution for recycle into the space 913 within the case 901, and the opening is opened/closed by an auxiliary cover 920.

Hard components such as calcium and magnesium and various kinds of impurities are removed by the water softening device 900 from hard water such as tap water supplied from an outside. Hence, the softened water is supplied to the water inflow space 611, such that the scale may be prevented from being generated on the inner circumferential surface of water inflow space 611 in the process of generating steam by the heater 640.

That is for precluding the scale generated on the inner circumferential surface of water inflow space 611 or the scale generated on the outlet path 630 in communication with the water inflow space 611 in case that hard water containing hard components and impurities is flowing and heated.

In case that the scale is generated on the inner circumferential surface of water inflow space 611, heat transmission to the water inflow space 611 through the heater may not be performed smoothly. Also, in case that the scale is generated on the outlet path 630, the outlet path 630 may be choked up and steam supply may not be performed smoothly.

Thus, the above problems may be prevented, because the water softened by the water treatment apparatus is supplied into the steam generator 600.

Although not described, the water softening device 900 may be varied in various structures.

More specifically, though the water softening device 900 uses ion-change resin and salt solution for recycle to ion-change, an energy filter which removes metal ion components such as heavy metal contained in water or a far-infrared-ray-emanated-ceramic-filter which can perform antibacterial action to soften water.

At that time, preferably the interior materials such as a filter are contained cases respectively and water passes through the cases in order, such that the water is softened cleaner.

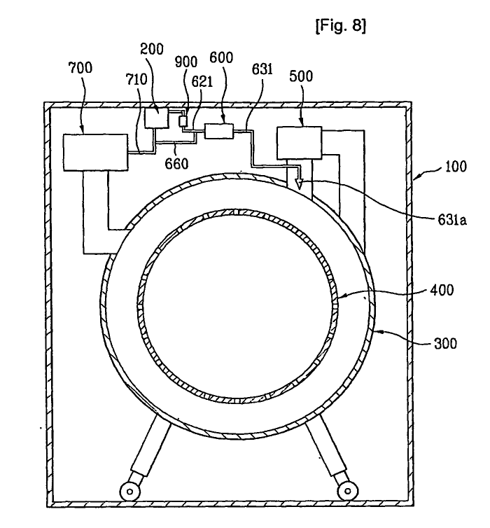

As shown in FIG. 7, the water softening device 900 may be provided between the outer water supply pipe 20 and the water supply valve 200 for softening the water supplied into the steam generator 600.

The water softened by the water softening device is supplied into the steam generator 600 connected with the water supply valve 200, and also into the drawer for detergent/fabric softener 700 connected with the water supply valve 200.

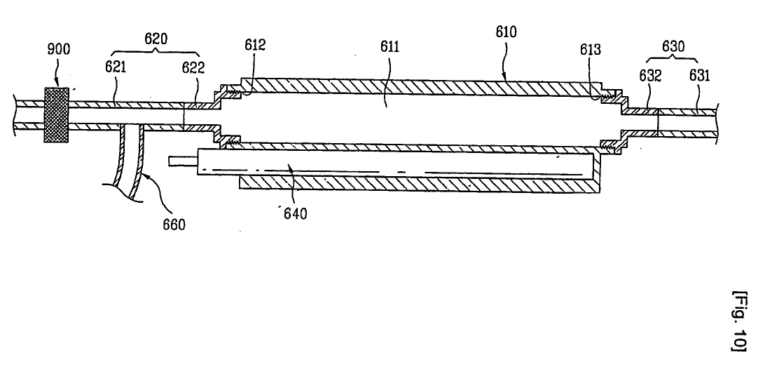

FIGS. 9 and 10 illustrate that a filtering device 900 is provided as one example of the water softening device for filtering water, and it is different from the above embodiment that the water softening device is a filtering device, not a water softening device.

As shown in FIG. 10, the filtering device 900 for filtering the water planned to be supplied into the steam generator 600 is a porous filter of a mesh type and may be provided in a water inlet pipe 620 supplying a pipe way to connect the water supply valve 200 and the steam generator 600.

That is, the filtering device 900 is provided in the water supply pipe 621 included in the water inlet path 620 of the steam generator 600, and filters foreign substance contained in the water flowing in the water inflow space 611, such that clean water without foreign substances is supplied into the water inflow space 611 of the steam generator 600.

Since the clean water is supplied into the water inflow space 611 of the steam generator 600, the scale is prevented from being generated on the inner circumferential surface of the water inflow space 611 in the process of generating steam by using the heater.

In case that water containing foreign substances is heated in the water inflow space 611, the scale containing calcium carbonate is generated not only in the water inflow space 611, but also in the outlet path 630 connected with the water inflow space 611.

Moreover, since the cross section of the path where steam is supplied from the steam generator to the tub is small, the scale should be prevented from being generated not to chock up the path due to the scale.

In case that the scale is generated on the inner surface of the water inflow space 611, the heater is not capable of transmitting heat into the water inflow space 611, whereas, in case that the scale is generated in the outlet path 630, steam may not be supplied smoothly.

Accordingly, the clean water relieved of foreign substances by the filtering device 900 is supplied into the steam generator 600, and then the above problems may be prevented.

Next, the operation of steam generator in the drying type laundry machine with a drying function will be described according to the embodiment of the present invention.

First, in a washing cycle of the drum type laundry machine with a drying function, the operation of steam generator will be described.

Once a washing cycle starts in the drum type laundry machine with a drying function, wash water and detergent mixed in the drawer for detergent/fabric softener 700 are loaded into a drum 400, and at the same time the steam generator 600 is operated to supply high-temperature steam into the drum 400 through a tub 300.

Thus, washing efficiency may be enhanced even with the small amount of wash water, because steam is supplied into the drum at the beginning of washing and laundry soaking as well as soil separation is performed smoothly.

At that time, laundry soaking and soil separation may be performed more quickly as well as more efficiently, because not only steam but also hot air is supplied into the drum 400 by turning on the ventilation fan 520 and the drying heater 510 for increasing the drum temperature and heating wash water.

Meanwhile, the steam generator 600 may supply wash water instead of steam into the drum 400 for reducing the time for the wash cycle or spinning cycle.

That is, in case that only wash water, not steam, is needed, the steam generator 600 is operated in a state where the heater 640 is off. Thereby, wash water may be supplied into the drum 400 also through the steam generator 600.

Thus, the time needed for supplying wash water may be reduced to shorten the entire washing time, because wash water scheduled to be supplied into the drum 400 is supplied through the two water inlet paths respectively connected with the drawer for detergent/fabric softener 700 and with the steam generator 600.

Next, in a drying cycle of the drum type laundry machine with a drying function, the operation of steam generator will be described.

Once a drying cycle starts in the drum type laundry machine with a drying function, power is applied to the drying heater 510 within the drying duct 500 and at the same time the ventilation fan 520 is driven, such that hot air is generated within the drying duct 500 and supplied into the drum 400.

Together with that, the steam generator 600 is operated to generate steam and the generated steam is supplied into the drum 400 through the tub.

Hence, the hot air and the steam generated together are drawn into the drum 400 for drying the laundry.

That is, since not only hot air but also steam is supplied into the drum during the drying cycle, the drum temperature may be increased quickly.

Thus, the laundry within the drum 400 may be quick-dried as well as sterilized and wrinkles thereof also may be smoothed out, resulting in a refreshing effect.

Next, in the other cycles of the drum type laundry machine with a drying function except the washing and drying cycle, the operation of steam generator will be described.

Once a refresh cycle for sterilizing the laundry and smoothing out wrinkles of the laundry starts in the drum type laundry machine with a drying function, the steam generator 600 generates and supplies steam into the drum 400 through the tub 300.

That is, only steam is supplied for smoothing out wrinkles of the laundry and sterilizing the laundry instead of washing or drying the laundry.

Thus, user satisfaction may be enhanced due to minimized wrinkles of laundry and sanitary washing.

It is preferred that the drum 400 is rotated in case that the steam generator 600 is operated in a washing, drying and refreshing cycle so that supplying the steam generated by the steam generator 600 may be supplied to the laundry.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### MODE FOR THE INVENTION

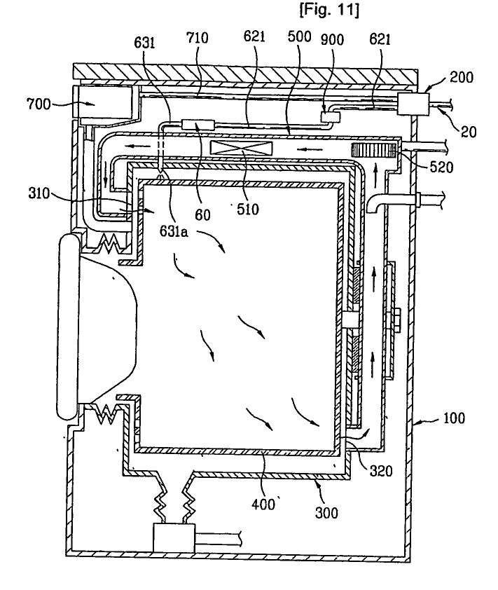

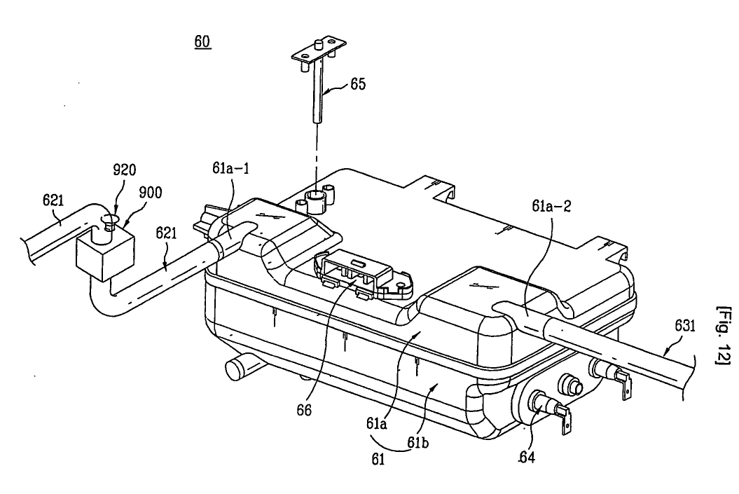

Referring to FIGS. 11 and 12, another type of steam generator 60 will be described.

The steam generator 60 includes a case 61, a water inlet path, an outlet path and a heater 64. The case 61 has an upper case 61a and lower case 61b for form pre-determined space to generate steam therein. The inlet path connected between the water supply valve 200 and a water inlet 61a-1. The outlet path connected between the outlet 61a-2 of the case 61 and the tub of the drum type laundry machine. The heater 64 is provided in the space of the case for heating water within the case 61.

Preferably, the steam generator 60 further includes a temperature sensor 65 for sensing the temperature of the case 61, and a water level sensor 66 for sensing the water level of the water supplied into the case 61.

The inlet path is a water supply pipe 621 connecting the water supply valve 200 and the inlet 61a-1 of the case, and the outlet path is a steam supply pipe 631 connecting the outlet 61a-2 of the case 61 and the tub 300.

Also, a water treatment apparatus 900 described before is further provided in case the above steam generator 60 is applied to a drum type laundry machine with a drying function.

Thus, since the structure of the water treatment apparatus 900 is the same as described before, the detailed description thereof will be omitted.

Furthermore, the seam generator 60 stores water supplied from the water supply valve 200 and heats the water to generate steam. Hence the steam is supplied into the drum 400 through the tub 300, unlike the steam generator 600 described before.

That is, since as much water as predetermined is stored and the stored water is heated to generate steam, the supplied water is not over flown. Thus, the component such as the bypass path 660 may be removed.

The present invention is not limited to the described embodiments, and it will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The advantageous industrial applicability of the present is described in the best mode in the specification.

1. A laundry machine comprising:
a body;
a water supply valve to connect with an outer water supply;
a drum rotatably mounted within the body;
at least one steam generator to generate steam to be supplied into the drum; and
a water treatment apparatus to treat water to be supplied to the steam generator.

2. The laundry machine of claim 1, wherein the water treatment apparatus is provided in at a pipe connecting to connect the outer water supply device and with the water supply valve.

3. The laundry machine of claim 1, wherein the water treatment apparatus is provided at a pipe to connect the water supply valve with the steam generator.

4. The laundry machine of claim 1, wherein the water treatment apparatus is a water softening device which makes water soft.

5. The laundry machine of claim 4, wherein the water treatment apparatus comprises a case having an inlet to draw water therein and an outlet to discharge softened water, the case having space to allow an interior material therein where the drawn water is softened.

6. The laundry machine of claim 5, wherein the interior material includes ion-exchange resin and salt solution for recycle.

7. The laundry machine of claim 1, wherein the water treatment apparatus includes a filtering device to filter water.

8. The laundry machine of claim 7, wherein the filtering device comprises a mesh type porous filter.

9. The laundry machine of claim 1, wherein the water treatment apparatus reduces or prevents scale from being generated in the steam generator.

10. The laundry machine of claim 9, wherein the steam generator comprises:
a steam generating part having a predetermined water inflow space therein to allow water to flow therein, the steam generating part having a water inlet and an outlet respectively connected with the water inflow space;
a water inlet path to connect between the water supply valve and the water inlet of the steam generating part;
an outlet path to connect between the outlet of the steam generating part and the tub drum; and
a heater to heat water flown into the water inflow space to generate steam.

11. The laundry machine of claim 10, wherein the steam generating part is positioned within the body of the laundry machine so that the outlet is positioned higher than the water inlet based on a horizontal line reference.

12. The laundry machine of claim 10, wherein the cross section of the steam generating part is larger than the cross section at least one of the water inlet path and outlet path.

13. The laundry machine of claim 10, wherein the cross section of the outlet path is smaller than the cross section of the water inlet path.

14. The laundry machine of claim 10, wherein the water inlet path comprises:
a water supply pipe having a first end thereof connected with a water supply valve; and
a water inlet pipe having a first end connected with a second end of the water supply pipe and a second end thereof connected with the water inlet of the steam generating part.

15. The laundry machine of claim 14, wherein the water treatment apparatus is provided at the water supply pipe.

16. The laundry machine of one of claims 10, wherein the steam generator further comprises a bypass path to discharge water over flowing from the water inflow space of the steam generating part.

17. The laundry machine of one of claims 10, wherein the outlet path comprises
an outlet pipe having a first end thereof connected with the outlet of the steam generating part; and
a steam supply pipe having a first end connected a second end of the outlet pipe and a second end thereof connected with the drum.

18. The laundry machine of claim 17, wherein the end of the steam supply pipe discharging steam is formed in a nozzle shape.

19. A laundry machine comprising:
a body;
a water supply valve to connect with an outer water supply device;
a drum rotatably mounted within the body;
a hot air supply device to generate and supply hot air into the drum through a drying duct;
at least one steam generator to generate steam to be supplied into the drum; and
a water treatment apparatus to treat water to be supplied to the steam generator from the water supply valve.

20. The laundry machine of claim 19, wherein the steam generated in the steam generator is supplied into the drum through the drying duct.

21. The laundry machine of claim 20, wherein the steam is supplied into the drum together with the hot air generated by the hot air supply device.

22. A laundry machine comprising:
a body;
a drum rotatably mounted within the body;
at least one steam generator to generate steam to be supplied into the drum; and
a water treatment apparatus including a water softening device to soften water to be supplied to the steam generator to reduce or prevent scale from being generated in the steam generator.

23. The laundry machine of claim 22, wherein the steam generator comprises:
a steam generating part having a predetermined water inflow space;
a heater which heats water flown into the water inflow space to generate steam.

24. The laundry machine of claim 22, further comprising a steam supply line pipe to provide a passage to the steam generated by the steam generator such that the steam can be directly supplied to the drum of the laundry machine.
